(19) United States
(12) Patent Application Publication
(10) Pub. No.: US 2011/0282739 A1
(43) Pub. Date: Nov. 17, 2011

(54) Method and System for Optimizing Advertising Conversion

(76) Inventors: Alex Mashinsky, Memphis, TN (US); Roger Y. Kim, Clifton, VA (US)

(21) Appl. No.: 13/105,331

(22) Filed: May 11, 2011

Related U.S. Application Data
(60) Provisional application No. 61/333,729, filed on May 11, 2010.

(51) Int. Cl. G06Q 30/00

(52) U.S. Cl. 705/14.53

(57) ABSTRACT

A call and web-based analytics system that optimizes advertising conversion includes collection of call and web-based transaction information to establish digital entity based on customer transaction history. The collection of call and web-based data establishes buyer purchasing cycle scorecard that reflects the buyer's transactional history. Advertisers can search, match and/or bid for customers that meet the criteria based on both call and web-based transactional history. Ads are delivered based on customer buying cycle process stage to match the timing of purchase and buying cycle. Optimized response rates and sales conversions are achieved by targeting matched ads during the customer purchasing cycle stage based on matched customer transactional history and collected customer profile information.

### CROSS REFERENCE TO RELATED APPLICATIONS

The present application claims priority to U.S. Provisional Patent Application No. 61/333,729 filed on May 11, 2010.

### FIELD OF INVENTION

The invention relates generally to operation of advertising systems. Specifically, the invention relates to call-based and web-based buyer communication and transaction analysis for optimized advertising conversion in advertising matching system.

### BACKGROUND OF THE INVENTION

There are problems in the current method of analyzing and presenting relevant advertisement for immediate or future needs of users. High conversion to sales from advertising is the primary objective, and it is rooted in delivering highly relevant and timely matching of advertising before or during user's buying process. Displaying ad at the right time of buyer's need is highly important in advertising. Historically sellers have blanketed the communication medium periodically to “brand” their product or service to users in hopes that the right buying audience will make a purchase, without knowing the timing of their need. This method yields low conversion from advertisement to sales. More targeted forms of advertising have emerged in the online world which utilize user profile and historical information to achieve closer correlation of what the user is searching for to yield higher ad conversion to sales. A salient example of targeted online advertising example is Google adwords that are displayed next to organic searches. Ad networks take into account users' visit on the web, stored cookie and other user interaction information to dynamically display ads that have higher conversion ratios. The assessment of a variety of web data, traffic or transaction, to understand the user experience online is called web analytics. Generally web analytics comprises of two techniques in capturing, or tracking, online interaction with users; web server logs and web page tags. Web server logs are data obtained from website server which can be analyzed by client software. These data include IP address, date and time of request, cookie, and item requested on web page. The next generation of web analytics is web page tags, which utilize Java Script on web pages to track user interaction. Java Script, any other dynamic client-based software code, page tag analytics obtain similar data as web server log-based system and a few more such as user IDs, session Ids, browser and operating system info. More importantly, they also obtain conversion data, which is unattainable from server logs.

In general, it is easier to track conversion to sales from online analytics and is more difficult to track conversions that are completed offline on a call, such as sales that are consummated on the phone or any transaction during a visit to a physical store. Current offline call tracking methods include inserting unique phone numbers on the web site that are not published elsewhere and Java Script-based web pages insert dynamic phone numbers to track the source of the traffic in order to identify users when they call into the unique inbound telephone number. The current integrated call-based and web-based methods are limited because they do not capture users' broad call interaction with various vendors, outside of specific ad campaign, their offline buying behavior, or the stage of their buying process cycle which yields higher conversion if relevant ads are displayed at the right buying cycle. Hence the lack of broad visibility in user transactions in offline world limits advertisers to only specific ad campaigns to a specific call inbound phone number, and to rely heavily on online web-based analytics on the website they control, which may not yield a broader set of users who may not know about their promotion. Without knowing the user's broad call transaction and interaction, relevant web-based online ads may not be displayed at the right, or opportune time of user's buying cycle. It yields lower conversion to sales because the advertiser has limited historical information about the user on their product or service only. Users make hundreds of telephone calls and make credit card transactions outside of web-basedworld to various vendors that they have existing relationship, or wish to make new relationship. There are certain demography of users who transact more exclusively on a call than online on a web for various personal reasons, including security. All relationship between existing vendor and user are finite for any product or service, and provides opportunity for other vendors to satisfy user's need. It can change after certain time period for various reasons, either through dissatisfaction or failure of the product or service. A washer or dryer purchased seven years ago may require repair service or need replacement. A telephone call to manufacturer service repair office number is not captured on web-based transaction to display relevant ad via fixed or mobile computing device. When a user goes online via web to search products and vendors, the current system tracks the user interaction other websites and displays ads without knowing that the user had made a call to manufacturer's repair service center yesterday and was on the call for 10 minutes. The goal is to capture the user call and web interaction so that most relevant ads are displayed at the right, opportune time to the user to convert into revenue generating sales. The current disparate call-based and web-based methods do not yield optimized ad conversion to sales.

### SUMMARY OF THE INVENTION

A method and system for delivering optimized advertising results by analyzing communications and transaction history of users in both web and call based systems. A user, either consumer or any business entity, interacts with both existing and new potential vendors in web and call-based communication and transaction systems. The analysis of call-based communication and vendor transaction history, and linking of such information to the user web and online identity with online web usage information establishes user buying preferences, brand loyalty and the likelihood to transact with specific products and services. Analyzing call and web-based transaction history enable the analytics system to access and establish a buyer purchasing cycle rating for users, or digital buying entity, for an advertising matching system. Broad collection of call and web-based data analysis, driven by advertiser criteria, produce more comprehensive view of targeted user buying behavior and relationship with vendors. By analyzing call frequency, duration, similar transactions or calls to related vendors, web usage statistics, and other statistically or heuristically relevant measurements, user purchasing cycle rating can be established. User purchasing cycle rating, or scorecard, on digital buying entity provides interested advertisers or third parties of ad space to bid on relevant ad placements in front of users matching the buying criteria and timing of purchase. Advertisers who use such system can identify their top targets by simply identifying the products, brands, companies or specific phone numbers they would like to target. The matching system translates such selections to specific matches of users and companies based on their willingness to buy such items. Such matches may then be used on ad networks or advertising exchanges to track and display ads to such users when they use the web or their computing devices.

Advertisers can achieve higher response rates and sales conversions by letting such system place matched ads on desktop or smart phone device that access search engines, ad networks, information sites, and vendor website during each phase of user purchasing cycle.

The inventive system uses a variety of ways to collect user interactions by for example monitoring key words entered into emails or chat programs, blogs and Tweet placements and other social network interactions. All such keywords are used to adjust or change the user profile as it relates to their willingness to buy specific products or services.

The advertisers can enter specific products, phone numbers, brands or company names and bid on users who have relationships or have transacted with them. Alternatively advertisers can promote specific products based on actions or communications performed by users.

The inventive system can correlate the links between a brand, the company that owns it, their phone and web site, the products they make and their competitors and match all such data to sets of users who already have used, purchased or other commercial relationships or are planning on engaging in such commercial relationships with such products or services. Since companies have many phone numbers the value bidders put on specific numbers or web pages indicate the importance of these pages for the purpose of bidding for other users.

Users for whom many phone and other transactions have been collected and who are interested by multiple advertisers but don't yet have any personally identifiable data including their web identity may be offered special products or services to provide such information and agree to certain terms and conditions of the inventive system. The reverse may be true as well for users with well established web profiles but no phone or off line history my be offered incentives to identify their phone, cell and other information so the profiles can be linked to maximize the systems ability to match users to advertisers. Users who agree to disclose their phone and web identities online or by using VoIP services can be automatically profiled and added to the central database.

Once such relational data (i.e. relationship between web and telephonic identities of the user) is established the system can track and expand on it even if a user changes his web profile or call contact info. The same information can be sold time and again to the same or new advertisers for different purposes as needs and products change or as usage decreases or is stopped.

In a VOIP phone call the communication system collects the IP address of the originating party and the destination number dialed, it could use ENUM or other directory to identify the originating party and the destination party. It could also use web caching servers to identify any browsing history or cookies on such user computer and create a profile for such user that includes such information. A central database can then link the identified destination number to a company, brands, products and services provided by such entity and add them to the user profile. If other transactions already exist in the user profile then a pattern of usage and ranking of such individual can be established and accessed by different advertisers. When a search is conducted by an advertiser and such profile is selected for targeting for specific ads or services an active retargeting profile is created and stored so when such user visits the web or uses his cell phone the inventive system is notified by ad networks or partner sites and it knows exactly which ad to deliver at what time from the profile created and from a database of ads provided by such advertisers.

### DESCRIPTION OF THE DRAWINGS

In the drawings:

FIG. 1 is a schematic block diagram of an exemplary network for use with the present invention;

FIG. 2 is a representation of an exemplary directory database used by the central controller of FIG. 1;

FIG. 3 is a representation of an exemplary targeted marketing database used by the central controller of FIG. 1;

FIG. 4 is a representation of an exemplary request information database used by the central controller of FIG. 1;

FIG. 5 is an exemplary method for facilitating targeted marketing over a network performed by the central server of FIG. 1;

FIG. 6 is a schematic diagram of call and web-based analytics system according to an embodiment of the present invention;

FIG. 7 is a flow diagram depicting call and web-based analytics process according to the method of the present invention;

FIG. 8 is a flow diagram depicting the calculation of user buying process scorecard according to the method of the present invention; and

FIG. 9 is another embodiment of the call and web-based analytics system according to the present invention.

### DETAILED DESCRIPTION OF THE PRESENTLY PREFERRED EMBODIMENTS

An embodiment of the present invention relates to a method and system for facilitating targeted marketing over a telecommunications network. The system includes a central controller that is capable of receiving data communication (such as voice communication, data (DNS), XML, Digital Object Identifiers (DOI), and/or the like) from an originating party to a terminating party. The identity of the terminating party is established and targeted marketing material (such as a coupon) for the terminating party or a competitor of the terminating party, is offered to the originating party.

In one example of the use of the present invention, a central controller functioning as a local data exchange may receive an information request (such as using a toll free phone call) from a customer to an airline booking and reservation center. In the process of transferring the request to the appropriate network service provider, the central controller determines the identity of the terminating party (such as the airline call center) by querying its own request directory database. Having determined the identity of the airline, the central controller next determines targeted marketing material based on the identity of the airline. In one exemplary embodiment, the targeted marketing material may be a coupon for a competing airline good for any national roundtrip ticket that is booked within the upcoming six months. The coupon is then provided to the customer, via any data communication means, such as via email, typical postal mail, the Internet, and/or the like.

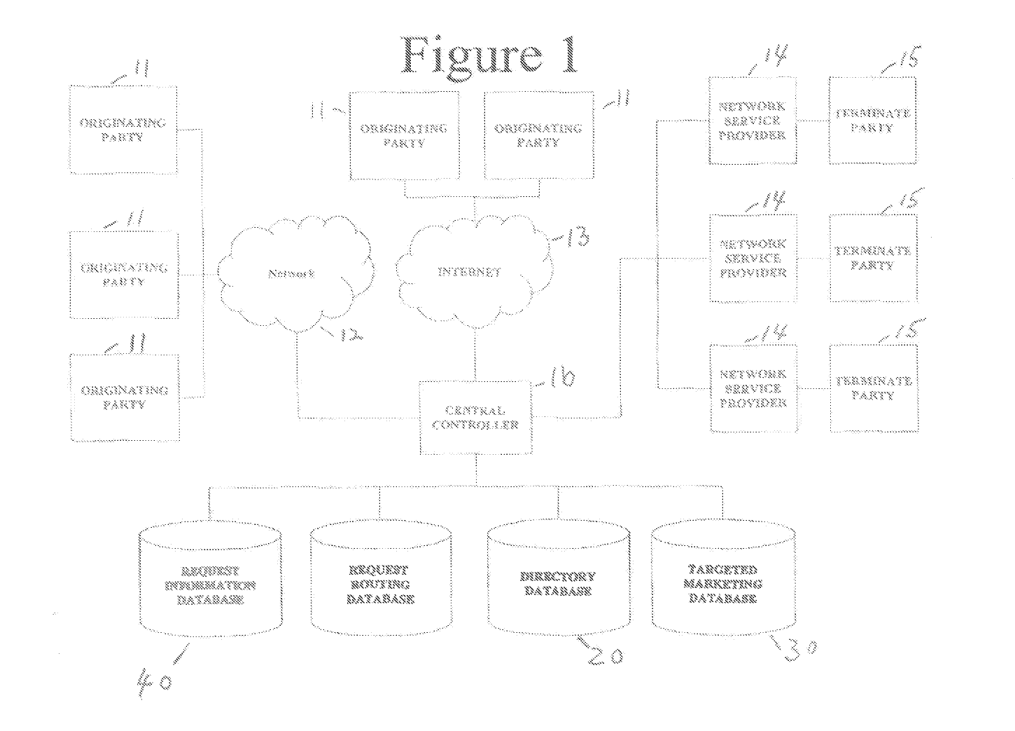

Referring to FIG. 1, the originating party 11 may be any entity capable of originating a request, such as a phone call or an Internet connection, in accordance with the invention. For example, the originating party 11 may be a consumer using his or her private telephone, or Internet account with a suitable Internet Service Provider (ISP).

The central controller 16 may be any entity capable of receiving, switching and transferring requests from one entity to another. For example, the central controller 16 may be a local exchange carrier, an ISP, an automated data manager, and/or the like.

Communication between the central controller 16 and the originating party 11 may take place over a dedicated network 12, or over the Internet 13 using any data transfer mechanism.

The network service provider 14 may be any entity capable of receiving and delivering a data request from the central controller 16 to a terminating party 15.

The terminating party 15 may be any entity capable of receiving a request from a network service provider 14. For example, the terminating party 15 may be a merchant or service provider such as an Airline registration center, a computer merchant's product sales center, and the like.

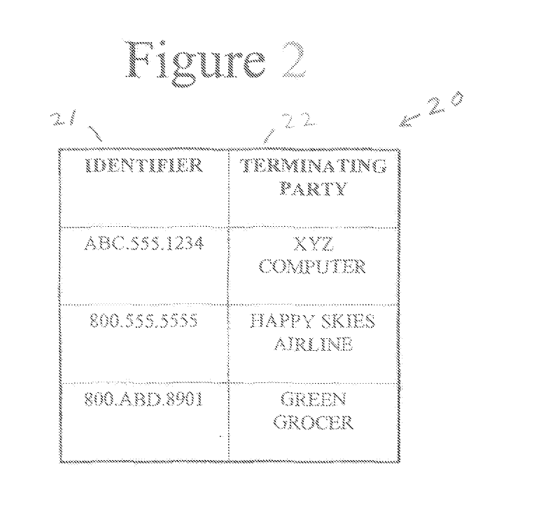

FIG. 2 is a tabular representation of the directory database 20 depicted in FIG. 1. The directory database may contain the following exemplary fields: an identifier field 21 storing a particular identifier and a terminating party field 22 for storing an identification of the party associated with the identifier.

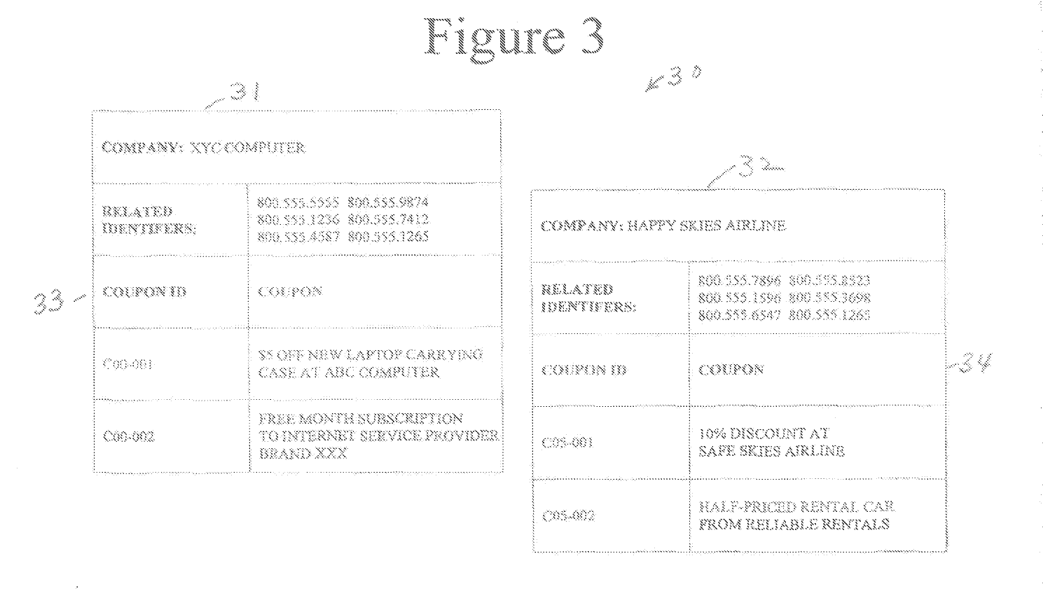

FIG. 3 is a tabular representation of the targeted marketing database 30 depicted in FIG. 1. The targeted marketing database may contain the following exemplary fields: company field 31, company identifiers field 32, coupon identification (ID) field 33, coupon field 34 and/or the like.

The company field 31 stores information relating to the name of a company for which marketing information is available.

The related company identifier numbers field 32 stores the identifying information that may trigger the provisioning of marketing material related to the company, or a competitor of the company. For example, if the company is “DELL COMPUTER,” one of the identifiers stored in this field 32 may be COMPAQ COMPUTER INC.'s toll free phone number, or the web page address of COMPAQ COMPUTER INC.

The coupon identification (ID) field 33 stores a unique coupon identifier associated with a coupon that may be provided on behalf of the company. In some embodiments of the invention, other forms of marketing material besides or in addition to coupons may be stored in this database 30.

The coupon field 34 stores information about the coupon identified by the coupon ID in field 33. For example, this field 34 may store the terms and conditions associated with the coupon.

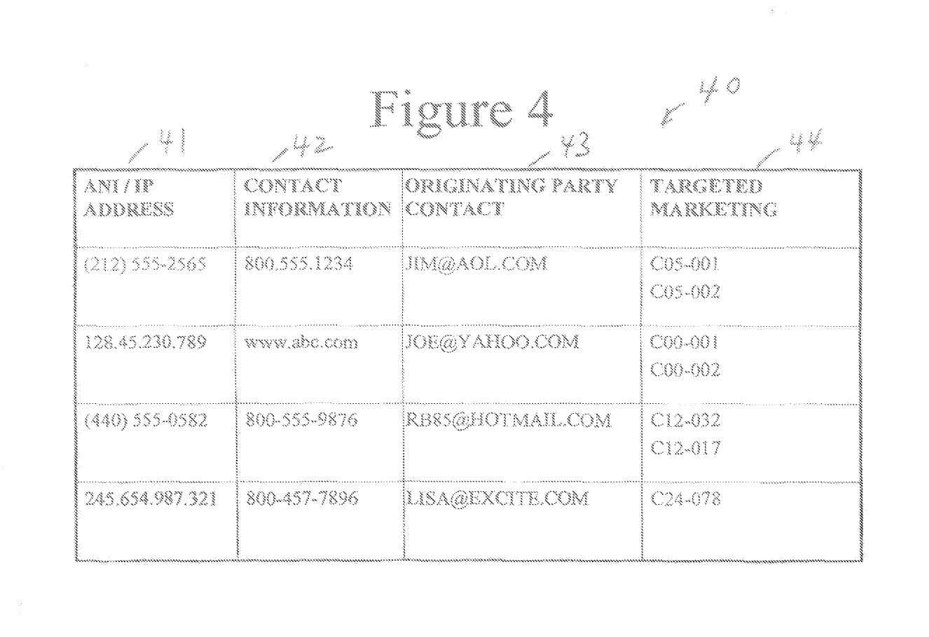

FIG. 4 is a tabular representation of the request information database 40 depicted in FIG. 1. The request information database 40 may contain the following exemplary fields: optional date/time field (not shown), automatic number identification/Internet Protocol (ANI/IP) address field 41, contact information field 42, originating party contact field 43, targeted marketing field 44 and/or the like.

An optional date/time field (not shown) may store information related to the date and time at which the central controller 16 received the toll-free call from the originating party 11.

The automatic number identification/Internet Protocol (ANI/IP) address field 41 stores information related to the phone number or IP address of the device used by the originating party 11 to contact the central controller 16. In embodiments where the originating party 11 uses a phone to contact the central controller 16, this address field may store the phone number (or Billing Number) associated with the phone. In embodiments where the originating party 11 uses a device capable of initiating an Internet-based connection, this address field 41 may store the IP address of the device.

The contact information field 42 stores information related to the contact mechanism employed by the originating party.

The originating party contact field 43 stores contact information related to the originating party 11. For example, the originating party 11 may provide the central controller 16 with an e-mail address by spelling the email address over the phone. The central controller 16 may then record the spelling of the e-mail address and translate the voice recording into text using a speech recognition program.

The targeted marketing field 44 stores information related to the targeted marketing material provided to the originating party 11. For example, this field 44 may store the coupon ID associated with the coupon provided to the originating party 11 according to present invention.

It should be noted that the user information is collected related to the requests made and the requests may be made using appropriate search engines and other locations where users interact with networks by using devices, such as phone calls and file transfers. The identity and context of the destination is correlated to specific interest by the user which can be dramatically enhanced by the cross reference of such destinations to their Standard Industrial Classification (SIC) classification and/or their DOI product information.

All such transactions are pre-authorized by the users or subscribers to the search engine or other service providers and allow such service provider to provide targeted product and industry information to their customers as well as much more accurate search results since it has the context of the interests and industries of interest to which that specific user belongs and it can cross reference its responses to be prioritized by such historical information. Such systems can be used by corporate networks as well to build specialized knowledge nets with background profiles of employees and their interests.

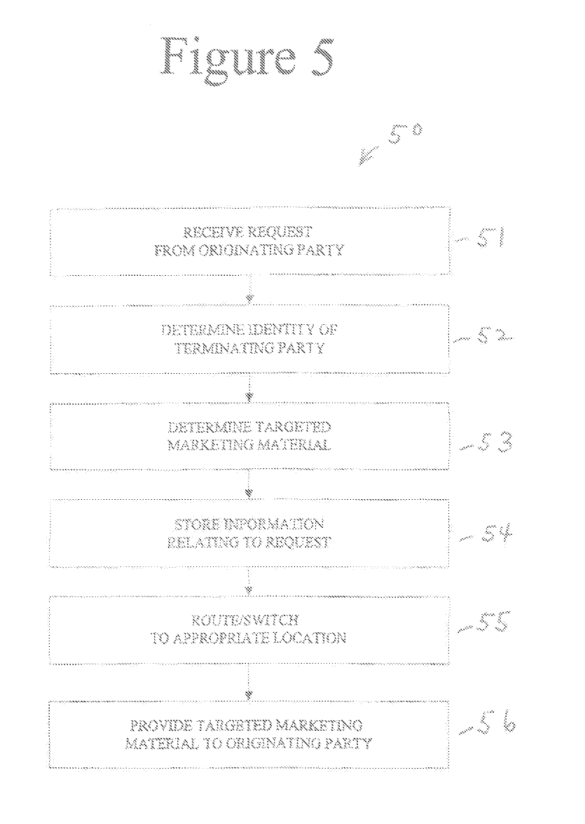

FIG. 5 is a flow chart describing a method 50 performed by the central controller 16 according to the present invention.

At step 51, a connection request is received from the originating party 11. According to the present invention, the central controller 16 receives the connection request from an originating party 11 to a terminating party 15. The request may reach the central controller 16 from the PSTN (normal phone call), from the Internet, and the like.

Next, at step 52, the central controller 16 determines the identity of the terminating party 15 by querying the directory database 20 that stores information associating contact information with the identities of the parties.

Next, at step 53, based on the identity of the terminating party 15, the central controller 16 determines appropriate targeted marketing material to be provided to the originating party 11. For example, the targeted marketing database 30 may be accessed and queried using the identity of the terminating party 15.

Alternatively, or in addition thereto, the central controller 16 may use cookies, ANI, forwarded information from other sources (e.g. Web sites), voice recognition, and the like in determining targeted marketing material. For example, in a VoIP embodiment, the system may identify cookies stored on the originating parties computer and use the identity of those cookies in the determination of targeted marketing material. In another example, the originating party's IP address may be used to help determine targeted marketing material. The system may access a database that stores information linking a given IP address with Web sites visited by that address. Such information may be useful in determining targeted marketing material. In general, determining the identity of the originating party 11 may prove useful in determining targeted marketing material.

The method 50 may continue to step 54 where the central controller 16 may store information associated with the originating party 11, the terminating party 15, the targeted marketing material, and the like in the appropriate field of the information database 40. This information may be useful for various purposes, such as for billing purposes, to determine the effectiveness of the targeted marketing by tracking the originating parties future behavior, and/or the like.

Next, at step 55, the central controller 16 queries a routing database (not shown) in order to determine the network service provider associated with the toll-free number. The routing database may have fields correlating the dialed phone number to the network service provider, or the like. Based on the network service provider, the central controller 16 switches the call appropriately.

Finally, at step 56, having determined targeted marketing material, the central controller 16 then provides the material to the originating party 11. There are a number of ways whereby the targeted marketing material may be provided to the originating party.

In one embodiment, the originating party 11 may provide the central controller 16 with his or her e-mail address, and the central controller 16 may e-mail the targeted marketing material to the e-mail address. The e-mail address may be received before, during or after the initial request is made. For example, the originating party 11 may be informed before the request to the terminating party 15 that he or she should stay on the line after making the information request to receive the money saving coupons. At the end of the connection, the central controller 16 may sever the connection with the terminating party 15 and prompt the originating party 11 to enter his or her e-mail address into the communicating device, at which point the central controller 16 may record the originating party's response and analyze it using an appropriate software (such as a speech recognition program) in order to convert the entered response/data into computer-readable data. Alternatively, the originating party 11 may speak or enter their physical home address, and the central controller 16 may arrange for the targeted marketing material to be delivered to his or her home by first class mail or the like.

In another exemplary embodiment, before, during or after the call, the central controller 16 may issue the originating party 11 a code and notify the originating party 11 that he or she may enter the code at a specified Web site in order to receive the targeted marketing material. For example, an originating party 11 who calls DELTA AIRLINES may be given a code to enter into the AMERICAN AIRLINES Web site. By entering the code, the originating party 11 may receive a discounted fare for a specified flight.

In a VoIP embodiment, where the originating party 11 is utilizing, for example, a personal computer (PC), the targeted marketing material may be communicated to the originating party 11 via a pop-up window that appears on the monitor of the PC. Such a window may appear before, during or after the connection is completed.

In certain embodiments, the provision of targeted marketing material may include actually switching the originating party's call from one terminating party 15 to another. For example, a customer may make a connection to DELTA AIRLINE's reservation center only to find that the current hold time is 25 minutes. The central controller 16 may offer to switch the customer to UNITED AIRLINE's reservation center, which may have only a 5 minute hold time. In another embodiment, the central controller 16 may switch the call automatically. The central controller may receive a fee or the like from the new terminating party 15 for the redirected call.

According to a presently preferred embodiment of the present invention, a system relates call and web-based user communication and transaction analytics for delivering relevant ads that match user buying cycle process, which will yield optimized advertising conversion. The analytics system leverages call and web-based transaction history with various vendors to identify the stage in the buying process cycle of targeted user for advertisers. The system collects transactional data related to phone calls, website interactions, emails and credit card transactions performed by users offline and online with vendors or merchants. The inventive system correlates call tracking with online web data without limitation to a specific advertising campaign, or deploying different phone numbers to track online ad campaign. Instead, advertisers can set specific criteria, for example a telephone number to specific vendor or competitor, to match a wider pool of targeted users who may fit their product or service based on past, or current offline and online transactional history with related vendors, and deliver ads that match the current buying process cycle based on user's transactional history. The present invention analyzes user habits and daily interactions with their brands to establish a digital identity that is categorized into a particular buying process cycle for certain type of product or service that advertisers would be interested in bidding and matching their relevant ad.

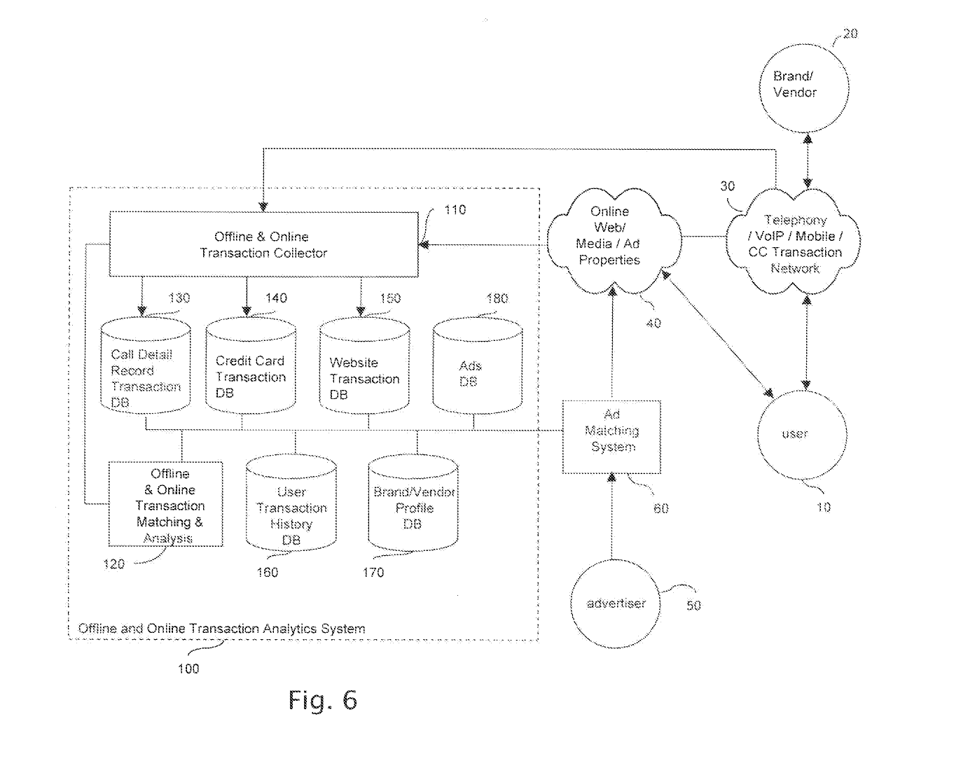

FIG. 6 illustrates call and web-based transaction analytics system in an embodiment of the present invention. The user 74, a retail consumer or business, calls a vendor 70, using telephone, Voice over Internet Protocol (VoIP), mobile, or engages in a credit card transaction through a call-based network 72 that is may be a TDM, cellular, satellite, or Internet Protocol network. The user 74 also interacts online with websites, media and Ad properties through the Internet 76 using smart mobile devices or PDAs, laptops, desktops and any Internet access capable device. The interaction with call-based network 72 is based on source and destination Automatic Number Identification (ANI) that telephone companies use to identify Directory Number (DN) of a calling subscriber. In general, ANI serves a function similar to Caller-ID. SS7 system, an out-of-band signaling system, supports voice and non-voice service by exchanging call control information, such as ANI, between network switching facilities. A call-based transaction collector 110 can interconnect directly, or indirectly through an intermediary or third party exchange based networks, with SS7 systems to collect source and destination call detail records related to Caller-ID, which is identified with the User 74. Similarly, Call Detail Records, which include time and duration of a call, can be collected by interconnecting directly with Soft Switches/Session Border Controllers (SS/SBC) of wholesale telecommunication carriers, or third party exchanges, that originate and terminate Voice over Internet Protocol (VoIP). These systems used in VoIP networks employ signaling and media session setup and tear down of telephone calls or other interactive media communications using SIP protocols. By interconnecting with these systems, either locally or remotely through a commercial relationship such as Skype, call detail records associated with User 74 Caller-ID ANI, IP Address, or ENUM (E.164 Number) can be collected and stored in Call Detail Record database 130 by Call-based Transaction Collector 110. User's 74 credit card transaction through the secured transaction network 72, or user 74 mobile phone calls via IP Multimedia Subsystem (IMS), or wireless network, require Caller-ID through a signaling system that establish and tear down calls. User 74 credit card transaction is conducted using a known designated billing address, payment or ordering phone number. User 74 calls this known number to purchase or make a payment to a person or automated Interactive Voice Response (IVR) credit card payment system. The offline credit card transaction to payment or ordering designated vendor or merchants are collected through the network 72 and stored in Credit Card transaction database 140 associated each User 74 Caller-ID and Vendor 70. By matching the ANI or Caller ID dialed or transactions processed to vendors 70 or users 74, or vice versa, user transaction history database 160 and vendor profile 170 can be correlated to associate user's 74 relationships with vendor 70 for any product or service. In doing so, each user 74 or vendor 70 is essentially given a digital entity with call-based transaction history within the system 100.

When user 74 connects with call-based network 72 to terminate a call to Vendor 70, the call session may be terminated through non Internet Protocol (IP) network via TDM or cell switched wireless, or satellite telephony network. However, the convergence of Internet Protocol in the call-based network 72 allows user smart devices 74, either fixed or mobile, to connect directly to online web and media network 76 utilizing IMS technology. Typically these calls are based on SIP and their unique identifier information such as IP address, Session ID, or User ID are needed to establish a call through a signaling system. When a user 74 interacts with various websites 76, various online web analytics tools are utilized by the operator of the website to provide vendors 70 and advertisers 80 with user online behavior. Web server logs provide cookie to identify unique visitor, item requested, date and time of the request, client IP address, and referrer to identify previous site or page visited (e.g., search engine, key word, or ad campaign that sent the user 74 to the site 76). Web page tags provide similar data as server logs. In addition, they provide customer Ids, tracking tags and conversion data as user completes transaction on the website. Web page tags deploy Java Script within the body of the web page itself to track user interaction and unique visitor. Each of these systems is backed by an e-commerce or Customer Relationship Management (CRM) system that identifies the unique visitor 74 to the website as customer's interaction and final conversion to sales occur. Through a commercial arrangement, the online web-based transaction collector 110 interconnects with third party operators of online analytics or directly with website 76 to obtain user online transaction and unique visitor data to be stored in website transaction database for each user 74. The online transaction collector 110 may utilize post transaction fetch as a batch storage, or as the transaction occurs using proprietary fetch and store. Because of sheer volume of data that need to be stored, the data must be converted to smaller proprietary data format to minimize the size of user call and web-based transaction data storage (130, 140, 150). The data format will include unique identifier such as User-ID/Caller-ID, date and time of transaction, duration, conversion occurrence, and among others. This proprietary data conversion to small data frame and subsequent transmission to online web-based transaction collector 110 can be inserted into the web page tags of online website 76 with commercial arrangement. The data conversion processing can occur on user device 74 as Java Script web page tag is interacted by the user and sent to the collector 110.

Once call and web-based transaction data is collected (130, 140, 150) per user 74, the data must be analyzed and matched 120. The correlation 120 of unique digital identifiers such as IP address, cookies, User ID to specific offline telephone numbers and CC transaction records is necessary to generate user transaction history 160 that can be analyzed to represent the likelihood to transact or purchase different products and services. The call and web-based transaction matching and analyzer 120 calculate the buying process scorecard relevant to each user 74 based on user transaction history 160, users 74 who have relationship with specific brand/vendor in a profile database 170. An advertiser 80 sets criteria for product or service category, as well as user transaction profile. For example, advertiser 80 may bid to advertising matching system 60 to search for all users 74 who have transacted with brand X during last 6 months. The advertising matching system 60 interacts with call and web-based analyzer 120 to search brand/vendor profile database 170 and user transaction history that matches advertiser 80 criteria. The call and web-based transaction analytics system 100 stores all ads of participating advertiser 80. Depending on the criteria that advertiser 80 specifies to the ad matching system 60, relevant ads that match the buying criteria from ads database 180 can be served by the ad matching system to the user 74 when user interacts online 76. Unlike other integrated call and web-based tracking analytics processing system, by gathering broad user transactional data and then linking it to different ad networks and aggregators of web traffic, a large collection of users 74 can be presented to advertisers 80 who want to reach specific audience.

To comply with relevant local or national laws, the user 74 may also set permission on the system 100 to allow or deny sharing of user transaction history 160 with others by opting out. The call and web-based transaction analytics system 100, which comprises above described components, except 74, 70, 72, 76, 80 and 60, may operate in a distributed client server environment or centralized environment. Certain components of system 100 may be processed at user 74 when the Java script on website 76 is interacted, and essential transaction tracking data is converted into appropriate format. The system 100 may also be stored and processed in a highly distributed architecture such as a cloud computing environment so as to leverage the storage and processing power of the Internet. Various functional elements may be combined or separated with different functions to optimize the operation of the system 100 to yield high advertising conversion to advertisers 80. One skilled in the art would appreciate that these various features and functions mentioned above can be omitted, rearranged or adapted in various ways.

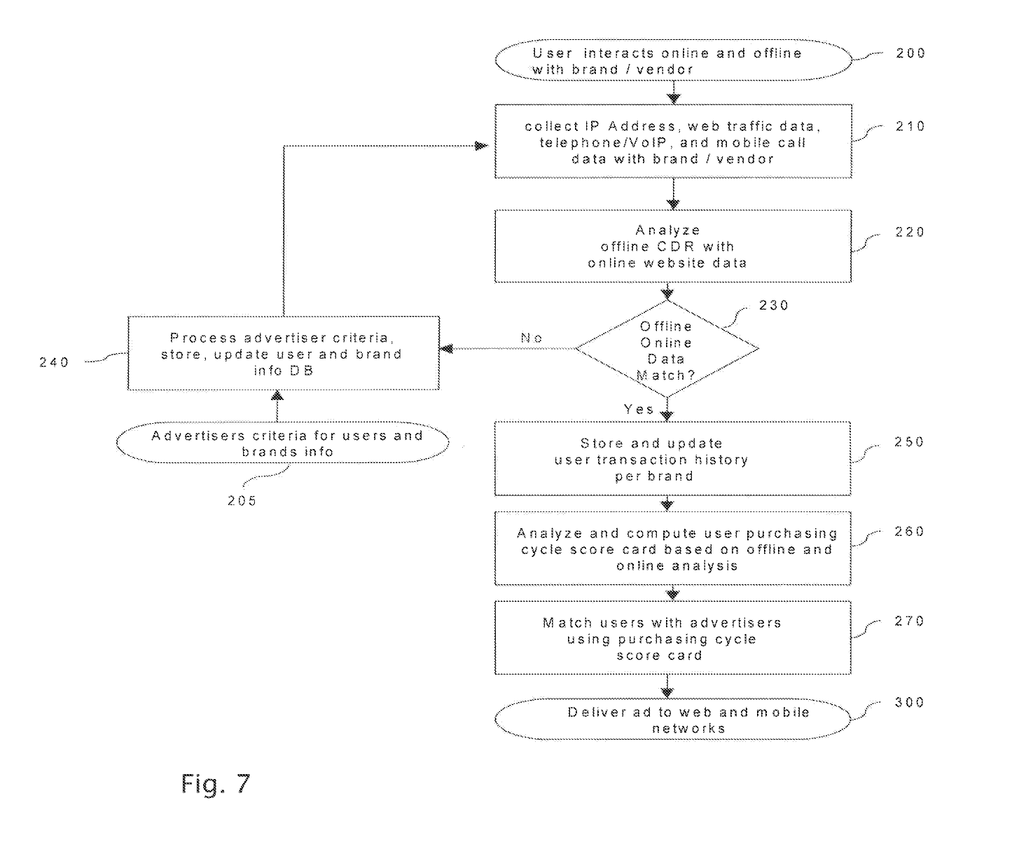

FIG. 7 depicts a call and web-based transaction analytics process flow diagram depicting an embodiment of the present invention. This embodiment supports the functional architecture described in FIG. 6. More specifically, the process occurs at the Transaction Collector 110 and the Transaction Matching and Analysis system 120. When user interacts on a call or on web with brands/vendors 200, a transaction history is recorded in call-based signaling system and online website analytics system. The system 100 collects unique identifiers and transaction information 210 such as User ID, IP address, cookie, Session ID, time and date of request, transaction date, item requested, source and destination ANI/DN (CallerID), ENUM, brand/vendor Internet domain name, and among others. Two basic matches must occur to correlate call and web-based data: user and vendor digital identity. The system 100 analyzes offline CDR with online website data 220 by correlating non-web based vendor's phone number with web-based vendor domain name. Each brand/vendor has unique domain name and the information can be searched dynamically on the Internet by the system 100, or the information is pre-stored in brand/vendor profile database 170 with matched pairs of phone numbers and domain name. Similarly, phone numbers and UserID can be pre-populated into user profile transaction history database 160, or collected then stored as the system 100 expands the database through commercial third party information providers. User's online or web identities can be gathered based on previous e-commerce transactions data that identifies user phone numbers. UserID associated with IP address, or cookies associated with the session, can be matched with phone numbers available in the system 100. If call and web-based information does not match in Step 230, because it is either new or different from what is stored in the system 100, a query is made in Step 240 to third party user information provider via Step 210 to resolve unmatched data. The feedback process makes the system more accurate to collect accurate data. If call and web-based information do match 230, the transaction data is update along with brand/vendor profile database 250. The user transaction history 160 database format may include and is not limited to the following: industry category, product category, vendor ID, User ID, User phone number, vendor domain name, vendor phone number, sales order/customer service/billing department code, date and time of interaction, transaction occurrence, duration of the call, frequency of call, frequency of website visits, website transaction conversion, user permission, previous matched ad conversion, buying cycle score card, geo coding tag, viewer/age rating code, and other relevant information that aid in higher ad conversion. For example, as it relates to department code parameter of data format, the system 100 can separate and differentiate calls or online web transaction made with a sales or support line of the same company. By placing different values to those codes, the value of a user who recently called a mortgage company sales number is much greater than another user who has recently called the billing number or URL domain name of same company.

The brand/vendor profile database 170 database format may include and is not limited to the following: industry category, product category, vendor ID, User ID, User phone number, vendor domain name, vendor phone numbers, total number of users in the system 100, and other relevant information that aid in advertiser criteria matching 205. Advertisers input their criteria 205 to the system 240 to process the request to store, update user transaction history so that their criteria matches what is already stored in the database 160 and 170, and what is not available in the system 100 so that it may collect IP address, web traffic data, telephone/VoIP, and mobile call data with a vendor in Step 210. Advertiser criteria 205 can be based on any subset of the user and brand data format items listed above. For example, advertisers 80 can list phone numbers, domain names, search terms or other unique identifiers that allow the system 100 to sort and aggregate all relevant users that match the criteria. If there is no match, or only a small number of users that match, the collector 210 searches call and web-based networks for more data.

Once the system 100 matches call and web-based data, user transaction history is analyzed to compute user purchasing cycle scorecard 260. The transaction history data provides a plethora of information to determine user-buying cycle. Based on specific transaction history, the system 100, through scorecard processing 260, can anticipate the next move or a transaction and prompt the user for specific discounts or promotions in an ad served by matched advertiser 80. All users 10 who have been determined to meet advertising criteria 205 are rated with user buying process scorecard 260. Certain users 10 may fall in problem recognition phase that may be days away from making a purchase, while other users 10 may need the product or service immediately because their scorecard indicate that they are actively pursuing a purchase. Unlike other analytics systems, more focused and relevant ad can be delivered during each distinct phase of a user buying cycle process because the system 100 is aware of buyer's call and web-based interaction with brands/vendors. Advertisers 80 are matched with users 10 based on purchasing cycle scorecard 270 and the ads are subsequently delivered to the user via web or mobile networks 300. This will result in better sales conversions and higher ad revenues for the advertiser 80 using the system 100. For example, advertisers who have access to the system 100 and ad matching system 60 can select brands, phone numbers, type of transactions, and other criteria to put a dollar value when all or some of these elements are qualified. This allows advertiser 80 to bid and agree to pay $0.50 for an credit card ad to be presented to an AMEX gold card holder in the research phase of buying cycle, but bid and pay $2 if the ad is to be displayed in front of an AMEX gold card holder who had called the AMEX customer service line in the past 2 days and made a visit to the Bank of America Visa ordering web site to apply for a new credit card within past 24 hours.

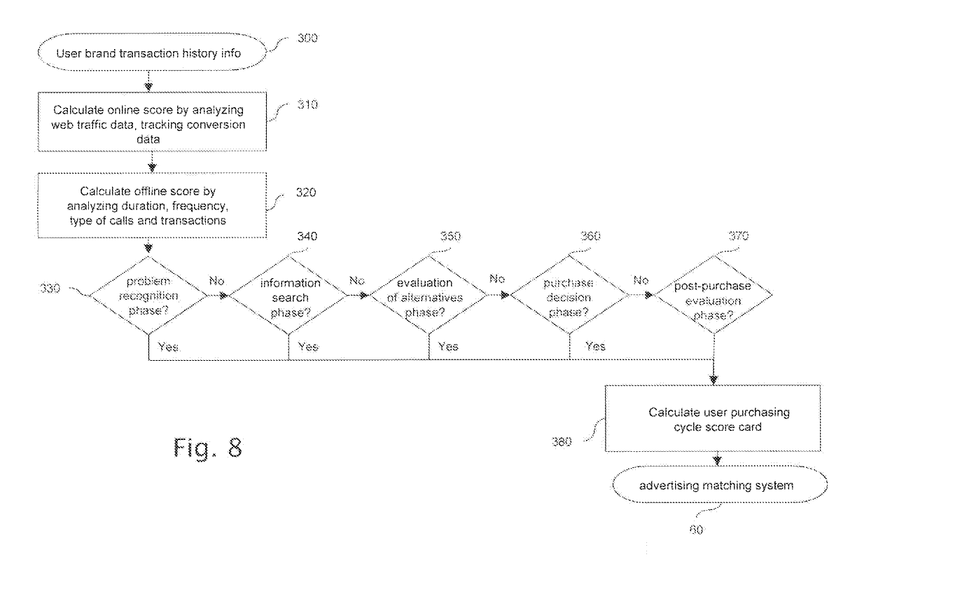

FIG. 8 is a flow diagram depicting the calculation of user buying process scorecard according to the method of the present invention. User transactional history 300 is used to evaluate online score based on web traffic data 310. Similarly call-based score 320 can be calculated based on user transactional history. Both of these processes 310 and 320 can be combined or separated based on Advertiser 80 requirements. In some cases, advertisers 80 may be more interested in call-based behavior of particular users because they have no visibility of web-based data relating to the users. The score can be based on a weighted statistical algorithm, heuristics, artificial intelligence, or neural networks to compute a scorecard. Some data parameters of user transaction data may have higher statistical value than other field parameters. A feedback mechanism from previous success of matching advertisers can also improve scorecard calculation 310 and 320. Once the score has been established, the score falls in one of five range of user buying process cycle: problem recognition phase 330, information search phase 340, evaluation of alternatives 350, purchase decision phase 360, and post purchase evaluation phase 370. Each phase has different value to different advertisers. By categorizing broad scope of users within these categories, better advertising match will occur based on user needs because timing of promotion or relevant call to action in an advertisement is critical in conversion to sales. The buying cycle categories can be more or less depending on advertiser requirements. The number of buying categories may be different with different industry or product codes. A user scorecard 380 is set once the purchasing cycle related to the industry is utilized to establish where the score fit in the range. The universe of matched users and the buying process scorecard are fed into the advertising matching system 60 to generate useful information to the advertisers.

By describing particular embodiments of the invention in this application, various alterations, modifications, and improvements will readily occur to those skilled in the art without departing from the spirit of the invention. Such alterations, modifications improvements, as made obvious by this disclosure, are intended to be part of this description though not expressly stated herein. Accordingly, the foregoing description is by way of example only, as a general matter of design choice, and not limiting. The invention, therefore, is limited only as indicated by the scope of the claims appended and equivalents hereto.

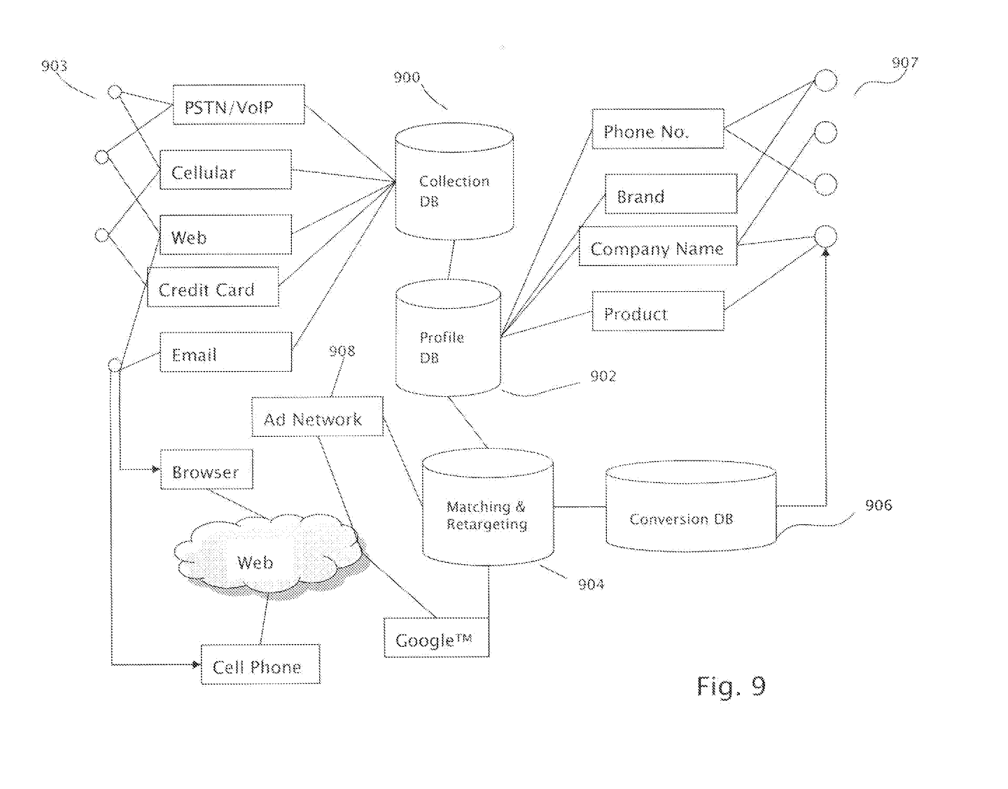

FIG. 9 diagrammatically illustrates a preferred embodiment of the inventive system comprising a Collection Database 900 for storing customers' commercial behavioral information from the various communications network (e.g. cellular, PSTN, and VoIP) and retail transaction systems (e.g. PayPal and credit card systems) and a Customer Profile database 902 for storing profile information of customers 903 relating to the telephone numbers, brands, company names, and products accessed, purchased, or inquired by the customers, which information may be provided by or accessible by the advertisers. The system further comprises a Matching and Retargeting module 904 that matches the data from the Collection database and the Profile database and causes an ad network or a search engine such as Google™ to display ads to those customers that are more relevant to their current activities on their phone or on the web. The module 904 may also access conversion information as when the customers 903 click on the ads or call an advertised phone number. A conversion database 906 collects the conversion information (e.g., the number of customers engaged in commercial transactions with the advertised service relative to the number of displayed advertisements) and sends such information to the advertisers 907. The advertisers 907 collect and collate the conversion information and analyze the customers commercial behavior with respect to relevant parameters such as the telephone numbers, brands, company names, and product and storing the further refined information in the Customer Profile Database 902 for later matching. In such a way, the feedback of the conversion information enables the system to continue to refine the algorithm for enhanced matching and retargeting of ads to those customers 903, thereby increasing the efficiency of their commercial activities on the web or by phone (e.g. PSTN or VoIP).

The Matching and Retargeting module 904 having an interface with the Ad network 908 and search engines selects from an ad contents database (not shown) and causes the display of advertisements on the customers' web browsers and/or phones. The display may be triggered based on the websites the customers 903 are visiting such as a travel related site and the module 904 determines based on the past behavior of the customer that he would be interested in information relating to luggage because he previously viewed a number of webpages concerning luggage on, for example, Amazon.com. Alternatively, the telephone numbers the customers 903 are calling would indicate to the module 904 that a class of company products should be advertised, which telephone numbers may be, for example, the customer support telephone number of a PC manufacturer (e.g. Dell™) for laptops. In this case, the module 904 would decide that information of HP laptops could be relevant to the customers 903 and cause the display of ads of HP laptops on the customers' smart phones or mobile devices.

The Collection Database 900 is connected to a gateway having the appropriate interfaces for accessing Call Detail Records from circuit switched networks including cellular networks and VoIP networks. Gateways may also be employed to access customer purchase data held by credit card companies via a secure interface. Alternatively, the credit card companies can filter out the confidential data and provides access to the non-confidential portion of the customer data such as the customer purchase history including products and dates. Preferably, gateways are employed at the edges of the carrier networks to handle the transfer of data and to access subscriber data kept by the carriers. The access points may be the MSC servers of a cellular system or the Service Data Points (SDPs) of the TDM networks. Alternatively, these networks may provide controllers for the management of updates of customer data to the Collection Database 900. The Collection Database 900 may also interface with email systems such as Gmail, Hot Mail, or Yahoo!Mail such that keywords in an email can be extracted and correlated with the email ID and thus the name of a customer. For example, the usage of the term “shipping” or “overnight delivery” in an email would indicate that the parties of such email exchange could be interested in the services of a courier such as FedEx.

The Customer Profile Database 902 may include information of a customer's history of calls to a company, purchase of products relating to a brand, the type of products such as cars, perfume, clothes purchased over the course of several years, etc. The information may be “pushed” or published to the Customer Profile Database 902 or may be accessed or “pulled” by the Customer Profile Database 902 from advertisers' or third party storage devices contain such information via a secure data link. Preferably, a server accesses the data from the advertisers' databases and converts such data to the appropriate format for the Profile Database 902. The Profile Database 902 preferably contains correlated customer information correlating, for example, a customer's demographics, preferences, purchase history, web surfing behavior, social network site information (e.g. FourSquare™, Twitter™, Flickr™ etc.).

The module 904 can correlate the links between a brand, the company that owns it, their phone and web site, the products they make and their competitors and match all such data to sets of users who already have used, purchased or other commercial relationships or are planning on engaging in such commercial relationships with such products or services. Since companies have many phone numbers the value bidders put on specific numbers or web pages indicate the importance of these pages for the purpose of bidding for other users.

Users or customers for whom many phone and other transactions have been collected and who are interested by multiple advertisers but don't yet have any personally identifiable data including their web identity may be offered special products or services to provide such information and agree to certain terms and conditions of the inventive system. The reverse may be true as well for customers with well established web profiles but no phone or off line history my be offered incentives to identify their phone, cell and other information so the profiles can be linked to maximize the system's ability to match customers 903 to advertisers 907. Customers 903 who agree to disclose their phone and web identities online or by using VoIP services can be automatically profiled and added to the Customer Profile database 902.

Once such relational data (i.e. relationship between web and telephonic identities of the user) is established the system can track and expand on it even if a user changes his web profile or call contact info. The same information can be sold time and again to the same or new advertisers for different purposes as needs and products change or as usage decreases or is stopped.

In a VOIP phone call the SIP server receives the IP address of the originating party and the destination number from the SIP user agent (e.g. a VoIP phone). The SIP server may use ENUM or other directory to identify the originating party and the destination party. It could also use web caching servers to identify any browsing history or cookies on such customer's computer and create a profile for such customer that includes such information. The Customer Profile database 902 can then link the identified destination number to a company, brands, products and services provided by such entity and add them to the user profile. If other transactions already exist in the customer profile then a pattern of usage and ranking of such individual can be established and accessed by different advertisers. When a search is conducted by an advertiser and such profile is selected for targeting for specific ads or services an active matching and retargeting profile is created and stored in the Customer Profile database 902 so when such the customer visits the web or uses his cell phone, the inventive system is notified by ad networks or partner sites and it knows exactly which ad to deliver at what time from the profile created and from a database of ads provided by such advertisers.

Advantageously, advertisers 907 who use such system can identify their top targets by simply identifying the products, brands, companies or specific phone numbers they would like to target. The Matching and Retargeting module 904 translates such selections to specific matches of users and companies based on their willingness to buy such items. Such matches may then be used on ad networks 908 or advertising exchanges to track and display ads to such users when they use the web or their computing devices. Advertisers 907 can achieve higher response rates and sales conversions by letting such system place matched ads on desktop or smart phone device that access search engines, ad networks, information sites, and vendor website during each phase of user purchasing cycle.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A computer-implemented method of targeting advertising information to customers, comprising:
Collecting customer transaction data from a plurality of customer purchase transactional databases;
Collecting customer profile information from web-based and phone-based relational databases;
Matching customer transaction data based on the collected customer profile information;
Targeting customers for advertisements based on matched customer transaction data, customer profile information, and characteristics of the advertisements; and
Displaying advertisements to the targeted customers via customers' computing devices.
